(19) United States
(12) Patent Application Publication
(10) Pub. No.: US 2014/0306082 A1
(43) Pub. Date: Oct. 16, 2014

(54) HANGING DEVICES, SYSTEMS AND METHODS

(71) Applicant: Priscilla J. Harvala, Osage, MN (US)

(72) Inventor: Priscilla J. Harvala, Osage, MN (US)

(21) Appl. No.: 14/254,556

(22) Filed: Apr. 16, 2014

Related U.S. Application Data
(60) Provisional application No. 61/812,433, filed on Apr. 16, 2013.

(51) Int. Cl. F16M 13/02

(52) U.S. Cl. CPC F16M 13/02
USPC 248/339

(57) ABSTRACT

Embodiments relate generally to the materials and methods for a device to hang objects, or a hanging device, wherein the device is flexible and versatile, such that it can be adapted to perform a desired function and suit the particular aesthetics of a variety of different organizational environments. Generally, embodiments provide advantages related to increased flexibility and versatility, thus allowing the user to use the same hanging device in a variety of different organizational environments.

### RELATED APPLICATION

This application claims priority to U.S. Provisional Patent Application No. 61/812,433, filed Apr. 16, 2013, the entirety of which is incorporated herein by reference.

### TECHNICAL FIELD

Embodiments relate generally to devices for hanging objects and more specifically to hanging devices which are flexible in form and versatile in function, such that the hanging devices can be adapted to temporarily hang a variety of different objects in a multitude of different locations and environments.

### BACKGROUND

The use of devices (i.e., hangers or hanging devices) to hang objects is well known in the fields of organization and design. Generally, hanging devices enable users to store, protect, and organize objects in a variety of environments. In the context of a bedroom or bedroom closet, hanging devices have been designed for clothing and clothing accessories, such that a specific item can be displayed in a manner that is stationary, secure, and easily visible to the viewer. In the context of a kitchen or bathroom, hanging devices have been designed for cloths, towels, utensils and other accessories, such that a specific item can be organized in a manner that makes it easily accessible to the user. Additionally, in the context of a garage or office, hanging devices have been designed for tools, supplies, and other equipment, such that a specific item that is not regularly used can be organized, stored, and protected for future use.

For example, hanging devices for clothing have been specifically designed to be triangular in shape, such that the article of clothing is kept off the floor and displayed in a manner that is easily visible to the viewer while retaining the article of clothing's general shape without undue wrinkling or creasing. Such devices for hanging clothing are generally rigid, with the hanging portion of the device in the same plane as the object-receiving portion of the device. In other organizational environments (e.g., kitchens, bathrooms, garages, offices, etc.), hanging devices have been developed to address a different set of user needs (e.g., storage, protection, concealment, organizing, etc.). For example, hanging devices for kitchen cloths and towels can be specifically designed such that the hanging portion of the device attaches to the side wall of a sink via a magnetic or suction mechanism, while the object-receiving portion of the device extends from the side wall of the sink to promote drying or store items within the sink cavity. Other kitchen hanging devices can be designed such that the hanging portion is attached to the top edge of the sink, while the object-receiving portion is suspended outside of the sink to promote drying or to store objects outside the sink cavity.

Generally, conventional hanging devices are designed for a specific purpose, object or environment. Moreover, many conventional hanging devices are rigid, and lack the flexibility and versatility that would enable a single device to be used in a variety of different ways and/or with a variety of different objects. Consequently, the user must purchase a different hanging device for each different organizational environment. Therefore, a need remains for a flexible, versatile hanging device that can be configured for use with a variety of objects in multiple environments.

### SUMMARY

Embodiments relate to hanging devices which are flexible in both form and functions, thereby being suitable for use with a variety of different objects to be hung in a variety of different situations and environments. In embodiments, the hanging device is versatile, such that it can be adapted to perform a desired function and suit the particular aesthetics of many different organizational environments. Depending on the organizational environment, for example whether the hanging device is to be used in the kitchen, bathroom or a closet, among other places, the hanging device can comprise and/or be selectively configurable into a variety of shapes, sizes, and dimensions.

In some embodiments, a hanging device can be selectively configured for use in a kitchen sink. The hanging portion can be selectively configured to secure the hanging device to a sink faucet, water filter, sprayer device or other sink accessory typically mounted on a surface proximate a sink, or to a portion of the sink itself. The object-receiving portion can generally be non-coplanar with respect to the hanging portion, such that the hanging portion extends generally outwardly over the sink from the faucet or other device to which it is mounted, while the object-receiving portion extends generally downwardly toward a bottom surface of the sink. A dishcloth, sponge, scrubber or other sink accessory can be easily placed on and/or removed from the object receiving portion. The particular relative configurations of the hanging portion and object-receiving portion can be customized by a user for virtually any sink configuration, faucet or device size, or object to be received thereon. Configured as such, the hanging device occupies a minimal amount of space within the sink and does not extend outwardly such that it interferes with a drain or running water while also keeping a dishcloth or other object hung thereon elevated with respect to a bottom of the sink.

In some embodiments, the object-receiving portion can comprise a securing portion configured to interact selectively with the hanger portion or another portion of the hanging device in order to selectively form a closed-loop object-receiving portion. Similar embodiments can be used in bathrooms, closets, garages, offices and other locations and environments. The flexibility and versatility exhibited by such embodiments offer many advantages for the user, including the ability to use a single device in a variety of different ways and/or with a variety of different objects. This feature can significantly reduce the time and money a user spends on organization and designing.

### BRIEF DESCRIPTION OF THE DRAWINGS

The invention can be more completely understood in consideration of the following detailed description of various embodiments of the invention in connection with the accompanying drawings, in which:

FIG. 1 depicts of a hanging device having an open object-receiving portion according to an embodiment.

FIG. 2 depicts a hanging device in use in a kitchen sink according to an embodiment.

FIG. 3 depicts a hanging device in the open configuration, wherein the hanging portion is supporting a wash cloth.

FIG. 4 depicts two hanging devices, a first of which is in a closed position, and a second of which is in the open configuration.

FIG. 5 depicts a hanging device in the open configuration, wherein the hanging portion is supporting cleaning supplies.

FIG. 6 depicts a hanging device in the open configuration, wherein the hanging portion is supporting hats.

FIG. 7 depicts a hanging device in the closed configuration.

FIG. 8 depicts a hanging device in the closed configuration, wherein the hanging portion is supporting a kitchen cloth.

FIG. 9 depicts a hanging device in the closed configuration, in a laundry room sink, wherein the hanging portion is supporting a cleaning cloth and drain plug, but is passively attached to a distinct anchoring object compared to FIG. 8.

FIG. 10 depicts a hanging device in the closed configuration, wherein the hanging portion is supporting necklaces.

FIG. 11 depicts a hanging device in the closed configuration, wherein the hanging portion is supporting shoulder and handbags.

FIG. 12 depicts a hanging device in the closed configuration, wherein the hanging portion is supporting umbrellas.

While the various embodiments of this application are amenable to various modifications and alternative forms, specifics thereof have been shown by way of example in the drawings and will be described in detail. It should be understood, however, that the intention is not to limit the invention to the particular embodiments as described. On the contrary, the intention is to cover all modifications, equivalents, and alternatives falling within the spirit and scope of the invention as defined by the appended claims.

### DETAILED DESCRIPTION

Embodiments relate generally to devices for hanging objects and more specifically to devices which are flexible in form and versatile in function, such that the devices can be adapted to temporarily hang a variety of different objects in a multitude of different locations and environments. Embodiments include hanging devices which are versatile, such that they can be adapted to perform a desired function and suit the particular aesthetics of many different organizational environments. Depending on the organizational environment, for example, whether the hanging device is to be used in the kitchen, bathroom or a closet, among other places, the hanging device can comprise and/or be selectively configurable into a variety of shapes, sizes, and dimensions. In some embodiments, the object-receiving portion can comprise a closed loop configuration, which can provide added strength and stability for heavier items (purses, bags, tools, etc.). In other embodiments, the object-receiving portion can comprise an open loop configuration, which can provide for the easy and convenient attachment and removal of certain items (e.g., belts, purses, hats, cloths, tools, etc.).

Embodiments can include hanging devices comprised of a variety of materials, including but not limited to, steel, stainless steel, iron, titanium, copper, aluminum, silicone, synthetic polymers (e.g., clear or tinted rubber and/or plastics), or any combinations thereof. In some embodiments, the material or materials used to construct the hanging device can be chosen such that a flexible or bendable end product is produced, enabling the hanging device to be adapted to function in a variety of organizational environments. For example, in embodiments the hanging device can comprise a stainless steel material, such as a welding rod, and can have a diameter of at least about ⅛″, such as about ¼″ or about ⅜″ in embodiments. Regardless of the materials used to construct it, some embodiments of the hanging device can be coated with a layer or layers of materials that offer functional advantages (e.g., prevents rusting and/or provides a smooth, non-snagging outer surface, protects one or more end portions, etc.) or enhance aesthetic appeal (e.g., by providing color, polish, etc.). In embodiments, the coating material can comprise one or more of a plastic, a vinyl, a fabric, a paint, a lacquer, a polymer, a rubber, a composite or another suitable material or combination of materials. In some embodiments, the hanging device or portions of the hanging device can be magnetized or fitted with objects that provide or enhance attachment via a mechanism other than, or in addition to, passive attachment (e.g., suction, magnetization, etc), or which facilitate or prevent interaction between the hanging device or objects secured thereon and other devices or surfaces (e.g., spacer or bumper attachments for separating the hanging device itself from a surface next to which it or an object thereon hangs). In embodiments, caps or end pieces can cover one or both ends of the hanging device to protect the ends and provide an attractive, finished appearance.

Embodiments can include hanging devices selectively configured to comprise a unitary structure of a contiguous piece of material, with the hanging portion formed at a first end and the object-receiving portion formed at a second end. The hanger portion can be sufficiently flexible in embodiments for selective reconfiguration thereof to enable the hanging portion to more closely conform to an object from which the hanging device is to be secured. The hanging portion can be configured to passively attach the hanging device to an anchoring object, such that the hanging device is suspended from, or is otherwise supported by, that anchoring object. The object-receiving portion can be configured to receive one or more objects to be supported by the hanging device. The object-receiving portion can be similarly flexible in embodiments to also enable the object-receiving portion to be selectively reconfigured for a particular object to be received thereon while at the same time retaining sufficient rigidity to enable the hanging device to generally retain a desired shaped or configuration once objects are hung thereon. In one embodiment, the object-receiving portion can comprise a closed loop configuration. In another embodiment, the object-receiving portion can comprise an open loop configuration. In some embodiments, the hanging device can be passively attached to many different anchoring objects (e.g., hooks, rods, holes, fixtures, etc.), which allow it to be used in a variety of different organizational environments.

Embodiments can also include hanging devices selectively configured such that the hanging portion and the object-receiving portion can be coplanar, while in other embodiments the hanging device can be selectively reconfigurable such that the hanging portion and object-receiving portion are non-coplanar. In one embodiment, the hanging portion is passively attached to an anchoring object such that the hanging portion and the object-receiving portion are coplanar and generally perpendicular to the anchoring object. In another embodiment, the hanging portion and the object-receiving portion can both be perpendicular to the floor or another base surface, but occupy different planes. For example, a user can passively attach the hanging portion of the device to an anchoring object (e.g., hook or rod) in a hall, mudroom, laundry, or bedroom closet, which can then allow the user to secure, organize, and store a plurality of clothing, clothing accessories, and/or household items (e.g., umbrellas, cleaning supplies, belts, handbags, purses, hats, jewelry, etc.). In another example, the user can passively attach the hanging portion of the device to an anchoring object in an office, such as a cubicle wall, bulletin board or other surface, which can then allow the user to secure, organize, and store a plurality of objects, including office supplies. In another example, the user can passively attach the hanging portion of the device to an anchoring object in a garage, which can then allow the user to secure, organize, and store a plurality of objects, including tools and hardware equipment.

Embodiments can also include hanging devices selectively configured to comprise a bend or angle between the hanging portion and the object-receiving portion, such that the hanging portion generally and the object-receiving portion are non-coplanar. In one embodiment, the hanging device can comprise an approximately 90-degree or right angle bend in the area between the hanging portion and the object-receiving portion. In other embodiments, this angle can be greater than or less than about 90 degrees and/or can be selectively customized by a user in use of any particular hanging device. When the hanging portion is passively attached to an anchoring object such that the hanging portion is generally parallel with a floor surface, the object-receiving portion will generally be perpendicular to the floor. For example, the user can passively attach the hanging portion of the device to the base of a kitchen faucet, which can then allow the user to hang a kitchen cloth from the object-receiving portion, such that the cloth is suspended from the object-receiving portion within the sink cavity and generally does not come in to contact with other surfaces except that of the hanging device. In some embodiments, this configuration can enhance drying and cleanliness. In another example, the user can passively attach the hanging portion of the device to an anchoring object in an office, which can then allow the user to secure, organize, and store a plurality of objects, including office supplies. In another example, the user can passively attach the hanging portion of the device to an anchoring object in a garage, which can then allow the user to secure, organize, and store a plurality of objects, including tools and hardware equipment.

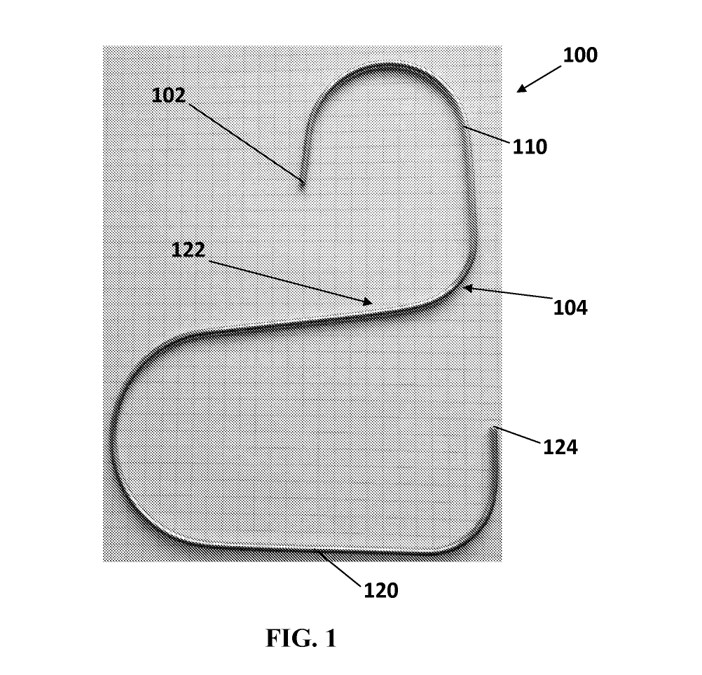

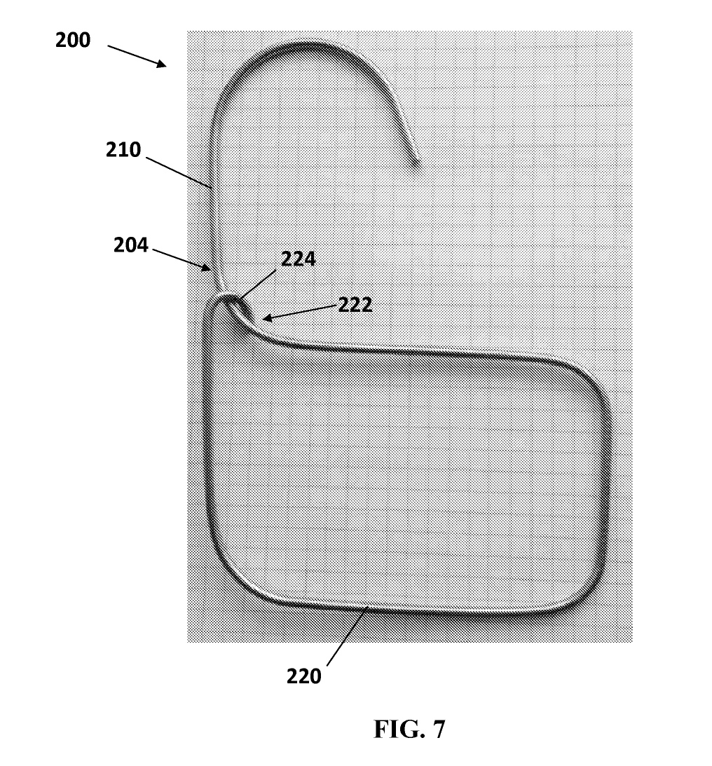

Referring to the drawings, FIG. 1 depicts a hanging device 100 according to an embodiment. In the embodiment of FIG. 1, hanging device 100 comprises a hanging portion 110 and an object-receiving portion 120. Hanging portion 110 comprises a first end 102 and a second end 104, with second end 104 coupled with a first end 122 of object-receiving portion 120. Object-receiving portion 120 also comprises a second end 124. In this embodiment, hanging device 100 comprises a contiguous structure, such that hanging portion 110 and object-receiving portion 120 comprise the same material and different portions of the same structure. In other embodiments, hanging portion 110 and object-receiving portion 120 can comprise different materials and/or structures coupled with another temporarily or permanently. As further depicted, the embodiment in FIG. 1 is in the open loop configuration, where the end 124 of object-receiving portion 120 does not attach to any other part of hanging device 100. In some embodiments, hanging device 100 can be selectively configured in the open loop position as shown, and then selectively reconfigured in the closed loop position (e.g., FIG. 7, explained below) by simple mechanical manipulation.

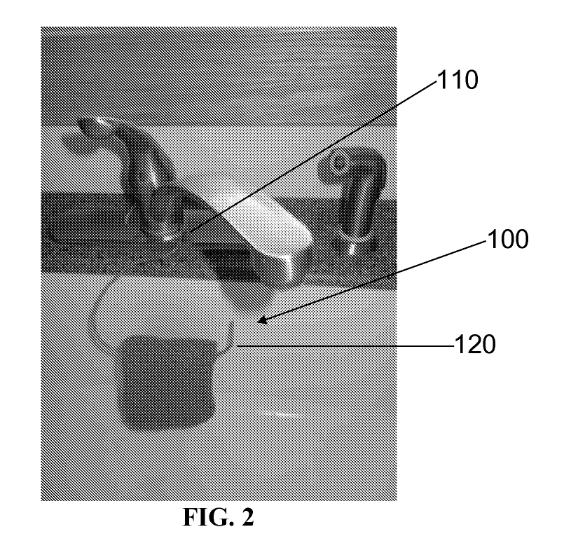

FIG. 2 depicts a hanging device 100 according to an embodiment. In the embodiment of FIG. 2, hanging device 100 is selectively configured for passive coupling with or attachment to an anchoring object. In this embodiment, hanging portion 110 is selectively configured to wrap around the base of a kitchen faucet, while object-receiving portion 120 extends out into the sink cavity from the side wall of the sink to promote drying or to store items within the sink cavity but elevated with respect to the drain or bottom surface of the sink. In this embodiment, hanging portion 110 and object-receiving portion 120 are generally non-coplanar, and in this and other embodiments the particular angle between hanging portion 110 and object-receiving portion 120 can vary and can be customized by a user according to the particular place in which device 100 is mounted and/or the object(s) being hung thereon. In embodiments, this angle can be greater than about 0 degrees to about 90 degrees, such as between about 10 degrees to about 45 degrees, though the angle can be greater than about 90 degrees in some embodiments. As selectively configured according to this embodiment, the hanging device 100 suspends the object, in this case a kitchen cloth, out into the sink cavity such that it does not come into contract with other surfaces, thus enhancing drying and cleanliness.

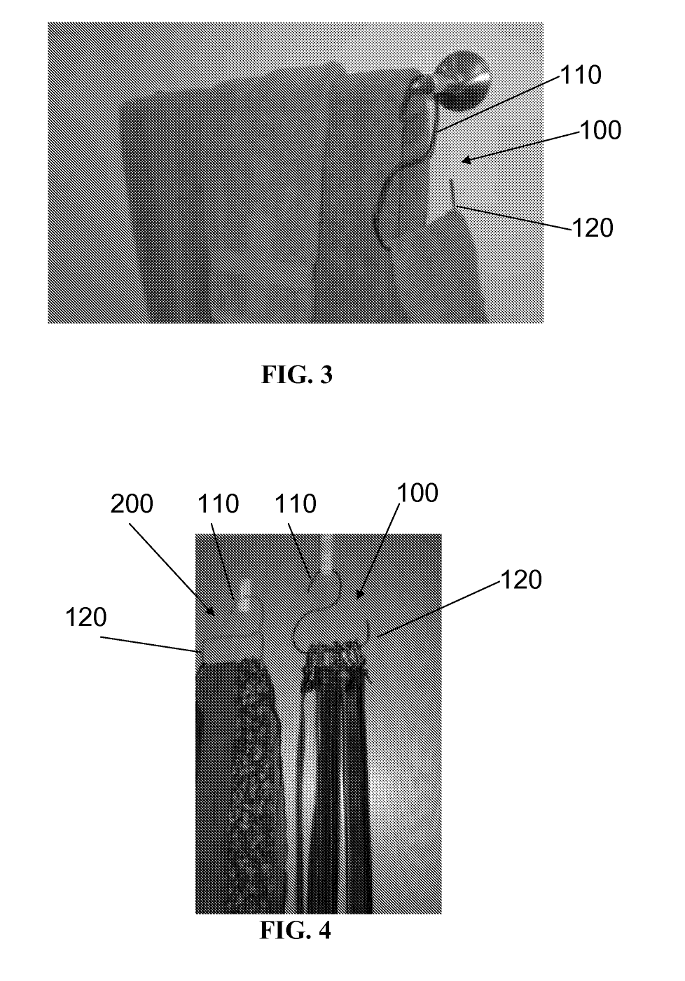

FIG. 3 depicts a hanging device 100 according to an embodiment. In the embodiment of FIG. 3, hanging device 100 is selectively configured for passive attachment to an anchoring object. In this embodiment, hanging portion 110 is selectively configured to wrap around a bathroom towel bar, while object-receiving portion 120 extends below. In this embodiment, hanging portion 110 and object-receiving portion 120 are generally coplanar, though hanging device 100 of FIG. 3 could be selectively reconfigured by a user to be used in a sink, as in FIG. 2, or some other environment as desired, providing versatility and convenience.

FIG. 4 depicts two hanging devices 100 and 200 according to embodiments. In the embodiment of FIG. 4, hanging device 100 is selectively configured for passive attachment to an anchoring object. In this embodiment, hanging portion 110 is selectively configured for attachment to a hook in a closet, mudroom, bedroom or other area, while the object-receiving portion 120 extends below. As depicted, hanging portion 110 and object-receiving portion 120 are coplanar. As further depicted in the embodiment of FIG. 4, hanging device 100 can be selectively configured for passive attachment to different anchoring objects in either open loop configuration 100 or closed-loop configuration 200. Hanging device 200 will be discussed in more detail below with reference to FIG. 7.

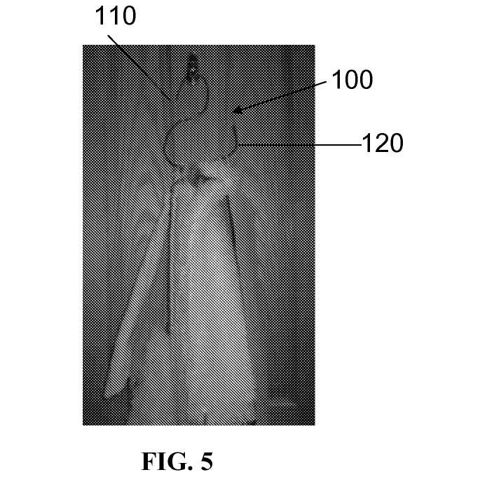

FIG. 5 depicts a hanging device 100 according to an embodiment. In the embodiment of FIG. 5, hanging device 100 is selectively configured for passive attachment to an anchoring object, for example a hook on a wall, door, cabinet or other surface. In this embodiment, hanging portion 110 is selectively configured for attachment to a hook on a laundry room closet door, while object-receiving portion 120 extends below. In this embodiment, hanging portion 110 and object-receiving portion 120 are coplanar. As further depicted in the embodiment of FIG. 5, hanging device 100 can be selectively configured for passive attachment to different anchoring objects in an open loop configuration, such that multiple items with loops (e.g., scarves or belts) can be easily attached to or removed from object-receiving portion 120.

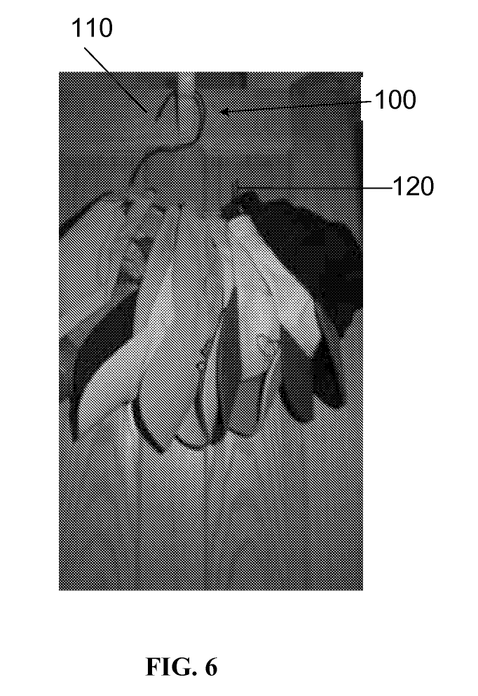

FIG. 6 depicts a hanging device 100 according to an embodiment. In the embodiment of FIG. 6, hanging device 100 is selectively configured for passive attachment to an anchoring object. In this embodiment, hanging portion 110 is selectively configured for attachment to a hook in a closet, mudroom, bedroom, garage or other area, while object-receiving portion 120 extends below. In this embodiment, hanging portion 110 and object-receiving portion 120 are coplanar. As further depicted in the embodiment of FIG. 6, hanging device 100 can be selectively configured for passive attachment to different anchoring objects in an open loop configuration, such that hats can be easily attached to or removed from the object-receiving portion 120. As shown, object-receiving portion 120 can be selectively configured to accommodate a larger number/volume of objects (e.g., FIG. 6), or a smaller number/volume of objects (e.g., FIG. 5) by simple mechanical manipulation.

FIG. 7 depicts a hanging device 200 according to an embodiment and to similar to or the same as one depicted in FIG. 4. In the embodiment of FIG. 7, hanging device 200 comprises a hanging portion 210 and an object-receiving portion 220. In this embodiment, hanging device 200 comprises a contiguous structure, such that hanging portion 210 and object-receiving portion 220 comprise the same material and different portions of the same contiguous structure. In other embodiments, hanging portion 210 and object-receiving portion 220 can comprise different materials and/or structures coupled with another temporarily or permanently. As further depicted, the embodiment in FIG. 7 is in the closed loop configuration, where second end 224 of object-receiving portion 220 attaches to hanging device 200 proximate first end 222 and/or second end 204 of hanging portion 210 to form a loop. In some embodiments, hanging device 200 can be selectively configured in the closed-loop position as shown, and then selectively reconfigured in the open loop position (e.g., FIG. 1) by simple mechanical manipulation.

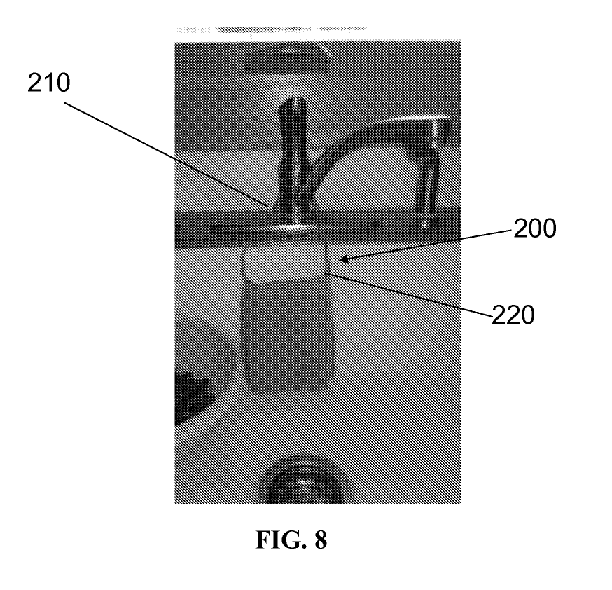

FIG. 8 depicts a hanging device 200 according to an embodiment. In the embodiment of FIG. 8, hanging device 200 is selectively configured for passive attachment to an anchoring object. In this embodiment, hanging portion 210 is selectively configured to wrap around the base of the kitchen faucet, while object-receiving portion 220 extends out into the sink cavity from the side wall of the sink to promote drying or to store items within the sink cavity. In this embodiment, hanging portion 210 and object-receiving portion 220 are non-coplanar. As selectively configured according to this embodiment, hanging device 200 suspends the object, in this case a kitchen cloth, out into the sink cavity such that it does not come into contract with other surfaces, thus enhancing drying and cleanliness.

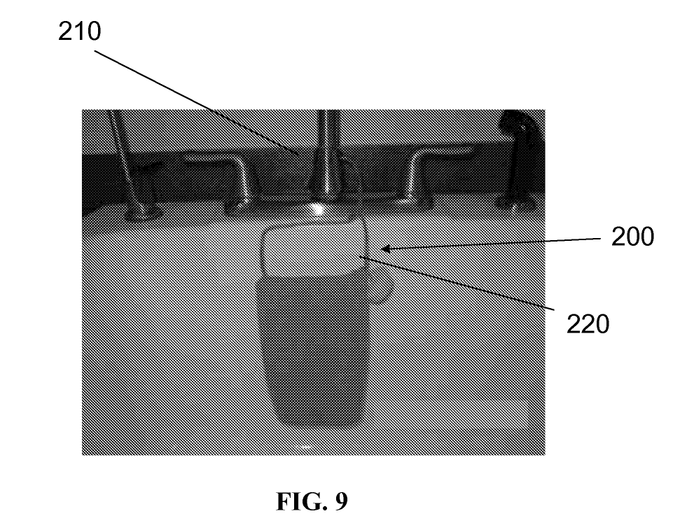

FIG. 9 depicts a hanging device 200 according to an embodiment. In the embodiment of FIG. 9, hanging device 200 is selectively configured for passive attachment to an anchoring object. In this embodiment, hanging portion 210 is selectively configured to wrap around the base of the laundry sink faucet (distinct from FIG. 8), while object-receiving portion 220 extends out into the sink cavity from the side wall of the sink to promote drying or to store items within the sink cavity. In this embodiment, hanging portion 210 and object-receiving portion 220 are non-coplanar. As selectively configured according to this embodiment, hanging device 200 suspends the object, in this case a scrubbing cloth and a drain plug, out into the sink cavity such that it does not come into contract with other surfaces, thus enhancing drying and cleanliness.

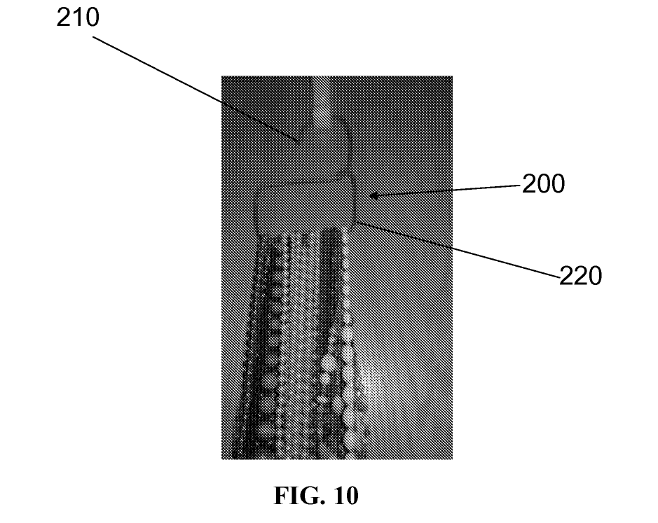

FIG. 10 depicts a hanging device 200 according to an embodiment. In the embodiment of FIG. 10, hanging device 200 is selectively configured for passive attachment to an anchoring object. In this embodiment, hanging portion 210 is selectively configured for attachment to a hook in a bedroom, while object-receiving portion 220 extends below. In this embodiment, hanging portion 110 and object-receiving portion 220 are generally coplanar.

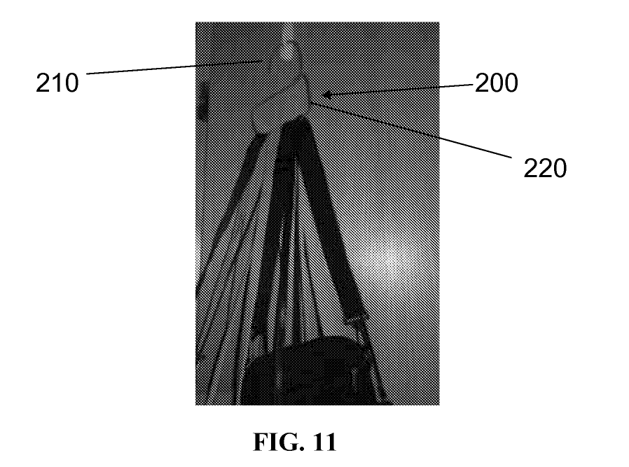

FIG. 11 depicts a hanging device 200 according to an embodiment. In the embodiment of FIG. 11, hanging device 200 is selectively configured for passive attachment to an anchoring object. In this embodiment, hanging portion 210 is selectively configured for attachment to a hook in a closet, mudroom, bedroom, garage or other area, while object-receiving portion 220 extends below. In this embodiment, hanging portion 210 and object-receiving portion 220 are coplanar. Also, the closed loop configuration of this embodiment can offer added strength and stability, such that hanging device 200 can hold multiple handbags, purses, and/or other heavier items.

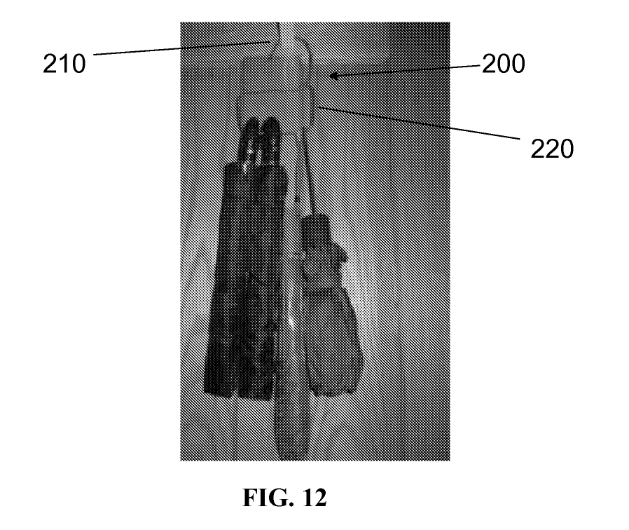

FIG. 12 depicts a hanging device 200 according to an embodiment. In the embodiment of FIG. 12, hanging device 200 is selectively configured for passive attachment to an anchoring object. In this embodiment, hanging portion 210 is selectively configured for attachment to a hook in a closet, mudroom, bedroom, garage or other area, while object-receiving portion 220 extends below. In this embodiment, hanging portion 210 and object-receiving portion 220 are coplanar. Also, the closed loop configuration of this embodiment can offer added strength and stability, such that hanging device 200 can hold multiple umbrellas and/or other objects.

Various embodiments of a hanging device are disclosed. These hanging devices and variations thereof provide numerous advantages, including but not limited to increased flexibility and versatility such that the hanging devices can be configured for use with a variety of objects in multiple environments. For example, in some embodiments, the hanging device can be selectively configured and reconfigured to be in the open loop or closed loop configurations. In other embodiments, the hanging device can be selectively configured such the object-receiving portion can accommodate a variety of different anchoring objects, and/or the hanging devices can be selectively configured to accommodate a larger or smaller number or volume of objects. In other embodiments, the hanging devices can be selectively configured to be coplanar, or they can be selectively configured to comprise a bend or angle between the hanging portion and the object-receiving portion, such that the hanging portion generally and the object-receiving portion are non-coplanar. These hanging devices and variations thereof provide increased flexibility and versatility, thus allowing the user to use the same hanging device in a variety of different organizational environments.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

What is claimed is:

1. A hanging device comprising:
a hanging portion having a first end and a second end, the hanging portion configured to passively and removably couple the hanging device to a support structure, the hanging portion being selectively configurable to conform at least one characteristic of the hanging device to the support structure; and
an object-receiving portion having a first end and a second end, a first end of the object-receiving portion coupled with the second end of the hanging portion, the object-receiving portion configured to selectively receive at least one object to removably secure the at least one object relative to the support structure.

2. The hanging device of claim 1, wherein the hanging portion lies substantially in a first plane and the object-receiving portion lies substantially in a second plane to define an angle between the first and second planes that is between about 0 degrees and about 90 degrees.

3. The hanging device of claim 2, wherein the angle is between about 10 degrees and about 45 degrees.

4. The hanging device of claim 3, wherein the support structure comprises a sink faucet, and wherein the angle is selected to secure the at least one object within a sink proximate the sink faucet and in a substantially non-contact orientation with respect to a surface of a sink.

5. The hanging device of claim 2, wherein the angle can be selectively altered.

6. The hanging device of claim 1, wherein the second end of the object-receiving to portion is configured to selectively couple proximate at least one of the second end of the hanging portion or the first end of the object-receiving portion such that the object-receiving portion comprises a substantially closed-loop to secure the at least one object therewithin.

7. The hanging device of claim 1, wherein the at least one characteristic of the hanging device comprises at least one of a radius of a portion of the hanging device, a dimension of a portion of the hanging device, an angle of a portion of the hanging device, a relative orientation between the first end of the hanging portion and the second end of the hanging portion, or a relative orientation between the hanging portion and the object-receiving portion.

8. The hanging device of claim 7, wherein the support structure comprises a rod, and wherein the at least one characteristic of the hanging device comprises a radius of the hanging portion selectively configurable to conform to a radius of the rod.

9. The hanging device of claim 1, wherein at least one of the hanging portion or the object-receiving portion comprises a material selected from the group consisting of steel, stainless steel, iron, titanium, copper, aluminum, silicone and a synthetic polymer.

10. The hanging device of claim 9, wherein at least one of the hanging portion or the object-receiving portion comprises a welding rod.

11. The hanging device of claim 10, wherein a diameter of the welding rod is between about ⅛ inch and about ½ inch.

12. The hanging device of claim 9, wherein at least a portion of the hanging device comprises a coating.

13. The hanging device of claim 10, wherein the coating comprises at least one of a plastic, a vinyl, a fabric, a paint, a lacquer, a polymer, or a rubber material.

14. The hanging device of claim 1, wherein a length of the object-receiving portion is greater than a length of the hanging portion.

15. The hanging device of claim 1, wherein the first end of the object-receiving portion is permanently coupled with the second end of the hanging portion.

16. The hanging device of claim 1, wherein the first end of the object-receiving portion is removable coupled with the second end of the hanging portion.

17. A hanging device configured to secure an object relative to an anchoring structure, comprising:
a hanging portion configured to passively and removably couple the hanging device to the anchoring structure, the hanging portion being selectively configurable to conform at least one characteristic of the hanging device to the anchoring structure, wherein the at least one characteristic comprises at least one of a radius of the hanging portion, a dimension of the hanging portion, a relative orientation between the hanging portion and another portion of the hanging device, or a relative orientation between a first end of the hanging portion and a second end of the hanging portion; and
an object-receiving portion coupled with the hanging portion and configured to selectively receive the object to removably secure the at least one object relative to the support structure.
